(19) United States
(12) Patent Application Publication
(10) Pub. No.: US 2022/0351150 A1
(43) Pub. Date: Nov. 3, 2022

(54) SYSTEMS AND METHODS FOR MANAGING AN INFORMATION HANDLING SYSTEM (IHS) BASED UPON A PROXY CALENDAR

(71) Applicant: Dell Products, L.P., Round Rock, TX (US)

(72) Inventors: Nikhil Manohar Vichare, Austin, TX (US); Richard C. Thompson, Cedar Park, TX (US); Vivek Viswanathan Iyer, Austin, TX (US)

(73) Assignee: Dell Products, L.P., Round Rock, TX (US)

(21) Appl. No.: 17/246,840

(22) Filed: May 3, 2021

(51) Int. Cl. G06Q 10/10; G06F 21/62

(52) U.S. Cl. CPC G06Q 10/1095; G06F 21/6245

(57) ABSTRACT

Embodiments of systems and methods for managing an Information Handling System (IHS) based upon a proxy calendar are described. In some embodiments, an IHS may include a processor and a memory coupled to the processor, the memory having program instructions stored thereon that, upon execution, cause the IHS to: receive context information, build a proxy calendar based upon the context information and in the absence of any access to calendar application data, and, in response to the proxy calendar indicating an event, perform one or more management actions associated with the event.

### FIELD

The present disclosure relates generally to Information Handling Systems (IHSs), and more particularly, to systems and methods for managing an IHS based upon a proxy calendar.

### BACKGROUND

As the value and use of information continue to increase, individuals and businesses seek additional ways to process and store it. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

Embodiments of systems and methods for managing an Information Handling System (IHS) based upon a proxy calendar are described. In an illustrative, non-limiting embodiment, an IHS may include a processor and a memory coupled to the processor, the memory having program instructions stored thereon that, upon execution, cause the IHS to: receive context information, build a proxy calendar based upon the context information and in the absence of any access to calendar application data, and, in response to the proxy calendar indicating an event, perform one or more management actions associated with the event.

For example, the context information may include at least one of: a day of the week, or a time-of-day. Additionally, or alternatively, the context information may include an AC or DC power mode. Additionally, or alternatively, the context information may include a presence or proximity of a user to the IHS. Additionally, or alternatively, the context information may include a location of the IHS. Additionally, or alternatively, the context information may include a conferencing application activity. Additionally, or alternatively, the context information may include at least one of: audio activity, or video activity. Additionally, or alternatively, the context information may include an IHS utilization metric. Additionally, or alternatively, the context information may include characteristic of a network connection. Additionally, or alternatively, the context information may include a characteristic of a battery utilization. Additionally, or alternatively, the context information may include an IHS posture.

In some cases, the event is selected from the group consisting of: (a) an in-person meeting at a primary location, (b) productivity time at a primary location, and (c) conference call from a remote location.

Moreover, the one or more management actions may include the selection of one of a plurality of fan settings. Additionally, or alternatively, the one or more management actions may include selection of one of a plurality of a power consumption settings. Additionally, or alternatively, the one or more management actions may include execution or cessation of a diagnostics or remediation process. Additionally, or alternatively, the one or more management actions may include execution or cessation of a system update process. Additionally, or alternatively, the one or more management actions may include execution or cessation of a telemetry collection process. Additionally, or alternatively, the one or more management actions may include setting the IHS in a selected security or locked mode.

In another illustrative, non-limiting embodiment, a memory storage device may have program instructions stored thereon that, upon execution by an IHS, cause the IHS to: request access to a user's calendar data, receive, from the user, a denial of the request, in response to the denial, build a proxy calendar based upon context information collected over time in lieu of any calendar application data, and, in response to the proxy calendar indicating an upcoming event, perform one or more management actions associated with the event.

In yet another illustrative, non-limiting embodiment, a method may include: building a proxy calendar based upon context information obtained by an IHS, where the context information excludes any calendar application data, and, in response to the proxy calendar indicating a predicted event, performing one or more management actions: (a) in anticipation of the event, (b) for a duration of the event, or (c) after termination the event.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a block diagram of an example of an Information Handling System (IHS) configured according to some embodiments.

FIG. 2 is a block diagram illustrating an example of a logic system configured to manage an IHS based upon a proxy calendar, according to some embodiments.

FIG. 3 is a flowchart illustrating an example of a method for managing an IHS based upon a proxy calendar, according to some embodiments.

FIGS. 4A and 4B are a table illustrating an example use-case of managing an IHS based upon a proxy calendar, according to some embodiments.

### DETAILED DESCRIPTION

Systems and methods are described for managing an Information Handling System (IHS) based upon a proxy calendar. In some embodiments, when actual calendar application data is not available, these systems and methods may be used to develop or set up a proxy calendar based on learned contextual information that excludes calendar data. Then, based upon the proxy calendar, these systems and methods may perform one or more management actions (e.g., systems management, security, audio settings or presets, video intelligent collaboration presets such as virtual background, session management settings, etc.). In some cases, the proxy calendar may be used to predict daily, weekly, and/or monthly events, and the one or more management actions may be performed in anticipation of, for the duration of, and/or immediately upon termination of the predicted event. The correlation between a type and/or duration of a predicted event and the management action(s) may be prescribed by a policy or the like.

In most enterprise or commercial settings, having access to a user's calendar may not be possible or desirable. In real-life situations, an employee may routinely or occasionally have personal, sensitive, private, secure, or protected data (e.g., medical appointments, personal annotations, etc.) that should be kept away from his or her employer for privacy and/or legal reasons (e.g., a user may mark down a doctor's appointment with name and address of a specialty doctor in meeting title). As such, access to a user's calendar data may require explicit user permission, for which the acceptance rate is low. Moreover, in the absence of a user's calendar application data, it would ordinarily not be possible to infer a mode of operation upon which intelligent behaviors (such as systems management, session management, intelligent audio-video, intelligent security, etc.) can be based.

Using systems and methods described herein, however, contextual information may create a proxy calendar for a user that predicts the state of the IHS in anticipation of actual calendar events (meeting durations, locations such as “local” or “remote,” travel plans, etc.), and intelligent behaviors may be triggered based on the proxy calendar rather than on the actual calendar application data which, again, may contain personal, sensitive, private, secure, or protected data.

For instance, if based on context information a user has been classified as a “corridor warrior”-type user who has frequent access to an AC charger after small battery discharge events, systems and methods described herein may determine not to fast charge the battery at every opportunity. However, if there is an upcoming proxy calendar event for a long meeting, systems and methods described herein may override that policy and charge the battery with fast charge without having access to the actual calendar application data that corresponds to the event.

Examples of management actions include, but are not limited to: setting different power modes, turbo modes, battery charge/discharge rates. power personas, wireless hardware enable/disable (e.g., WWAN on in secure environments), retrieve or apply authentication tokens and certificates, presence or proximity detection settings (e.g., snooze period), intelligent audio/video settings (e.g., set virtual background, audio presets, one-click settings, etc.), etc.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

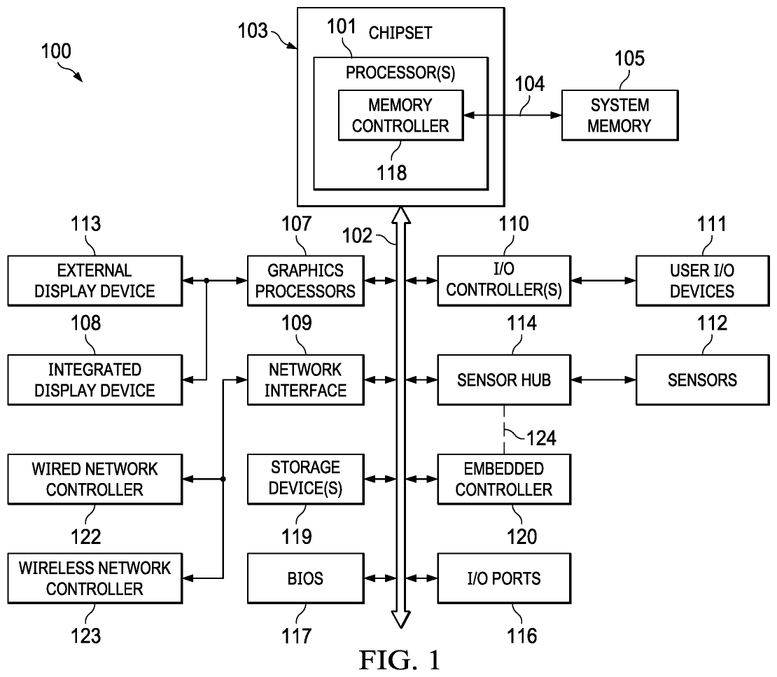

FIG. 1 is a block diagram illustrating components of IHS 100 configured according to some embodiments. As shown, IHS 100 includes one or more processors 101, such as a Central Processing Unit (CPU), that execute code retrieved from system memory 105.

Although IHS 100 is illustrated with a single processor 101, other embodiments may include two or more processors, that may each be configured identically, or to provide specialized processing operations. Processor 101 may include any processor capable of executing instructions, such as an Intel Pentium™ series processor or any general-purpose or embedded processors implementing any of a variety of Instruction Set Architectures (ISAs), such as the x86, POWERPC®, ARM®, SPARC®, or MIPS® ISAs, or any other suitable ISA.

In the embodiment of FIG. 1, processor 101 includes an integrated memory controller 118 that may be implemented directly within the circuitry of processor 101, or memory controller 118 may be a separate integrated circuit that is located on the same die as processor 101. Memory controller 118 may be configured to manage the transfer of data to and from the system memory 105 of IHS 100 via high-speed memory interface 104. System memory 105 that is coupled to processor 101 provides processor 101 with a high-speed memory that may be used in the execution of computer program instructions by processor 101.

Accordingly, system memory 105 may include memory components, such as static RAM (SRAM), dynamic RAM (DRAM), NAND Flash memory, suitable for supporting high-speed memory operations by the processor 101. In certain embodiments, system memory 105 may combine both persistent, non-volatile memory and volatile memory. In certain embodiments, system memory 105 may include multiple removable memory modules.

IHS 100 utilizes chipset 103 that may include one or more integrated circuits that are connect to processor 101. In the embodiment of FIG. 1, processor 101 is depicted as a component of chipset 103. In other embodiments, all of chipset 103, or portions of chipset 103 may be implemented directly within the integrated circuitry of the processor 101. Chipset 103 provides processor(s) 101 with access to a variety of resources accessible via bus 102. In IHS 100, bus 102 is illustrated as a single element. Various embodiments may utilize any number of separate buses to provide the illustrated pathways served by bus 102.

In various embodiments, IHS 100 may include one or more I/O ports 116 that may support removeable couplings with various types of external devices and systems, including removeable couplings with peripheral devices that may be configured for operation by a particular user of IHS 100. For instance, I/O 116 ports may include USB (Universal Serial Bus) ports, by which a variety of external devices may be coupled to IHS 100. In addition to or instead of USB ports, I/O ports 116 may include various types of physical I/O ports that are accessible to a user via the enclosure of the IHS 100.

In certain embodiments, chipset 103 may additionally utilize one or more I/O controllers 110 that may each support the operation of hardware components such as user I/O devices 111 that may include peripheral components that are physically coupled to I/O port 116 and/or peripheral components that are wirelessly coupled to IHS 100 via network interface 109.

In various implementations, I/O controller 110 may support the operation of one or more user I/O devices 110 such as a keyboard, mouse, touchpad, touchscreen, microphone, speakers, camera and other input and output devices that may be coupled to IHS 100. User I/O devices 111 may interface with an I/O controller 110 through wired or wireless couplings supported by IHS 100. In some cases, I/O controllers 110 may support configurable operation of supported peripheral devices, such as user I/O devices 111.

As illustrated, a variety of additional resources may be coupled to processor(s) 101 of IHS 100 through chipset 103. For instance, chipset 103 may be coupled to network interface 109 that may support different types of network connectivity. IHS 100 may also include one or more Network Interface Controllers (NICs) 122 and 123, each of which may implement the hardware required for communicating via a specific networking technology, such as Wi-Fi, BLUETOOTH, Ethernet and mobile cellular networks (e.g., CDMA, TDMA, LTE).

Network interface 109 may support network connections by wired network controllers 122 and wireless network controllers 123. Each network controller 122 and 123 may be coupled via various buses to chipset 103 to support different types of network connectivity, such as the network connectivity utilized by IHS 100.

Chipset 103 may also provide access to one or more display device(s) 108 and/or 113 via graphics processor 107. Graphics processor 107 may be included within a video card, graphics card or within an embedded controller installed within IHS 100. Additionally, or alternatively, graphics processor 107 may be integrated within processor 101, such as a component of a system-on-chip (SoC). Graphics processor 107 may generate display information and provide the generated information to one or more display device(s) 108 and/or 113, coupled to IHS 100.

One or more display devices 108 and/or 113 coupled to IHS 100 may utilize LCD, LED, OLED, or other display technologies. Each display device 108 and 113 may be capable of receiving touch inputs such as via a touch controller that may be an embedded component of the display device 108 and/or 113 or graphics processor 107, or it may be a separate component of IHS 100 accessed via bus 102. In some cases, power to graphics processor 107, integrated display device 108 and/or external display 133 may be turned off or configured to operate at minimal power levels in response to IHS 100 entering a low-power state (e.g., standby).

As illustrated, IHS 100 may support an integrated display device 108, such as a display integrated into a laptop, tablet, 2-in-1 convertible device, or mobile device. IHS 100 may also support use of one or more external displays 113, such as external monitors that may be coupled to IHS 100 via various types of couplings, such as by connecting a cable from the external display 113 to external I/O port 116 of the IHS 100.

In certain scenarios, the operation of integrated displays 108 and external displays 113 may be configured for a particular user. For instance, a particular user may prefer specific brightness settings that may vary the display brightness based on time of day and ambient lighting conditions.

Chipset 103 also provides processor 101 with access to one or more storage devices 119. In various embodiments, storage device 119 may be integral to IHS 100 or may be external to IHS 100. In certain embodiments, storage device 119 may be accessed via a storage controller that may be an integrated component of the storage device. Storage device 119 may be implemented using any memory technology allowing IHS 100 to store and retrieve data.

For instance, storage device 119 may be a magnetic hard disk storage drive or a solid-state storage drive. In certain embodiments, storage device 119 may be a system of storage devices, such as a cloud system or enterprise data management system that is accessible via network interface 109.

As illustrated, IHS 100 also includes Basic Input/Output System (BIOS) 117 that may be stored in a non-volatile memory accessible by chipset 103 via bus 102. Upon powering or restarting IHS 100, processor(s) 101 may utilize BIOS 117 instructions to initialize and test hardware components coupled to the IHS 100. BIOS 117 instructions may also load an operating system (OS) (e.g., WINDOWS, MACOS, iOS, ANDROID, LINUX, etc.) for use by IHS 100.

BIOS 117 provides an abstraction layer that allows the operating system to interface with the hardware components of the IHS 100. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

As illustrated, certain IHS 100 embodiments may utilize sensor hub 114 capable of sampling and/or collecting data from a variety of hardware sensors 112. For instance, sensors 112, may be disposed within IHS 100, and/or display 110, and/or a hinge coupling a display portion to a keyboard portion of IHS 100, and may include, but are not limited to: electric, magnetic, hall effect, radio, optical, infrared, thermal, force, pressure, touch, acoustic, ultrasonic, proximity, position, location, angle, deformation, bending, direction, movement, velocity, rotation, acceleration, bag state (in or out of a bag), and/or lid sensor(s) (open or closed).

In some cases, one or more sensors 112 may be part of a keyboard or other input device. Processor 101 may be configured to process information received from sensors 112 through sensor hub 114, and to perform methods for prioritizing the pre-loading of applications with a constrained memory budget using contextual information obtained from sensors 112.

For instance, during operation of IHS 100, the user may open, close, flip, swivel, or rotate display 108 to produce different IHS postures. In some cases, processor 101 may be configured to determine a current posture of IHS 100 using sensors 112 (e.g., a lid sensor, a hinge sensor, etc.). For example, in a dual-display IHS implementation, when a first display 108 (in a first IHS portion) is folded against a second display 108 (in a second IHS portion) so that the two displays have their backs against each other, IHS 100 may be said to have assumed a book posture. Other postures may include a table posture, a display posture, a laptop posture, a stand posture, or a tent posture, depending upon whether IHS 100 is stationary, moving, horizontal, resting at a different angle, and/or its orientation (landscape vs. portrait).

For instance, in a laptop posture, a first display surface of a first display 108 may be facing the user at an obtuse angle with respect to a second display surface of a second display 108 or a physical keyboard portion. In a tablet posture, a first display 108 may be at a straight angle with respect to a second display 108 or a physical keyboard portion. And, in a book posture, a first display 108 may have its back resting against the back of a second display 108 or a physical keyboard portion.

It should be noted that the aforementioned postures, and their various respective keyboard states, are described for sake of illustration. In different embodiments, other postures may be used, for example, depending upon the type of hinge coupling the displays, the number of displays used, or other accessories.

In other cases, processor 101 may process user presence data received by sensors 112 and may determine, for example, whether an IHS's end-user is present or absent. Moreover, in situations where the end-user is present before IHS 100, processor 101 may further determine a distance of the end-user from IHS 100 continuously or at pre-determined time intervals. The detected or calculated distances may be used by processor 101 to classify the user as being in the IHS's near-field (user's position <threshold distance A), mid-field (threshold distance A<user's position <threshold distance B, where B>A), or far-field (user's position > threshold distance C, where C>B) with respect to IHS 100 and/or display 108.

More generally, in various implementations, processor 101 may receive and/or produce context information using sensors 112 including one or more of, for example: a user's presence state (e.g., present, near-field, mid-field, far-field, absent), a facial expression of the user, a direction of the user's gaze, a user's gesture, a user's voice, an IHS location (e.g., based on the location of a wireless access point or Global Positioning System), IHS movement (e.g., from an accelerometer or gyroscopic sensor), lid state (e.g., of a laptop), hinge angle (e.g., in degrees), IHS posture (e.g., laptop, tablet, book, tent, and display), whether the IHS is coupled to a dock or docking station, a distance between the user and at least one of: the IHS, the keyboard, or a display coupled to the IHS, a type of keyboard (e.g., a physical keyboard integrated into IHS 100, a physical keyboard external to IHS 100, or an on-screen keyboard), whether the user operating the keyboard is typing with one or two hands (e.g., holding a stylus, or the like), a time of day, software application(s) under execution in focus for receiving keyboard input, whether IHS 100 is inside or outside of a carrying bag, ambient lighting, a battery charge level, whether IHS 100 is operating from battery power or is plugged into an AC power source (e.g., whether the IHS is operating in AC-only mode, DC-only mode, or AC+DC mode), a power consumption of various components of IHS 100 (e.g., CPU 101, GPU 107, system memory 105, etc.).

In certain embodiments, sensor hub 114 may be an independent microcontroller or other logic unit that is coupled to the motherboard of IHS 100. Sensor hub 114 may be a component of an integrated system-on-chip incorporated into processor 101, and it may communicate with chipset 103 via a bus connection such as an Inter-Integrated Circuit (I²C) bus or other suitable type of bus connection. Sensor hub 114 may also utilize an I²C bus for communicating with various sensors supported by IHS 100.

As illustrated, IHS 100 may utilize embedded controller (EC) 120, which may be a motherboard component of IHS 100 and may include one or more logic units. In certain embodiments, EC 120 may operate from a separate power plane from the main processors 101 and thus the OS operations of IHS 100. Firmware instructions utilized by EC 120 may be used to operate a secure execution system that may include operations for providing various core functions of IHS 100, such as power management, management of operating modes in which IHS 100 may be physically configured and support for certain integrated I/O functions. In some embodiments, EC 120 and sensor hub 114 may communicate via an out-of-band signaling pathway or bus 124.

In various embodiments, IHS 100 may not include each of the components shown in FIG. 1. Additionally, or alternatively, IHS 100 may include various additional components in addition to those that are shown in FIG. 1. Furthermore, some components that are represented as separate components in FIG. 1 may in certain embodiments instead be integrated with other components. For example, in certain embodiments, all or a portion of the functionality provided by the illustrated components may instead be provided by components integrated into the one or more processor(s) 101 as an SoC.

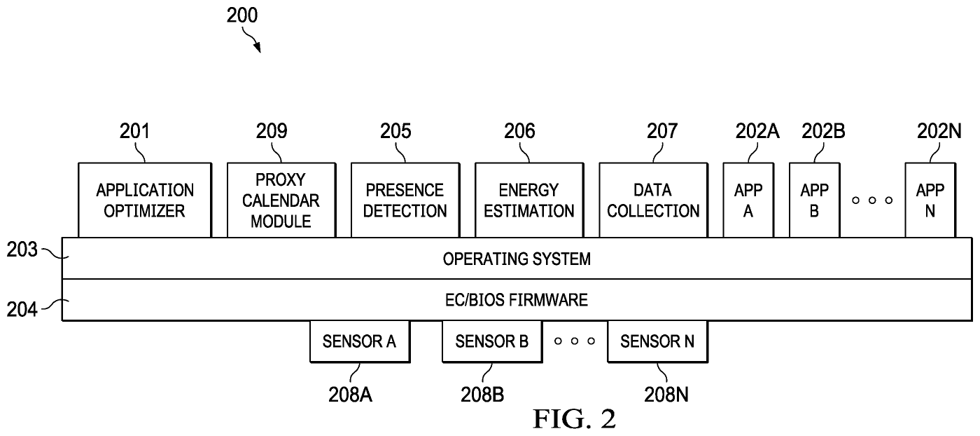

FIG. 2 is a block diagram illustrating an example of logic system 200 for managing an IHS based upon a proxy calendar. In some embodiments, each element of logic system 200 may be provided by IHS 100 through the execution of program instructions by one or more hardware components (e.g., CPU 101, BIOS 117, EC 120, etc.) stored in memory (e.g., system memory 105), storage device(s) 119, and/or firmware 117, 120.

As shown, logic system 200 includes application optimizer engine 201 configured to manage the performance optimization of applications 202A-N. An example of application optimizer engine 201 is the DELL PRECISION OPTIMIZER Meanwhile, examples of applications 202A-N include, but are not limited to, computing resource-intensive applications such as remote conferencing applications, video editors, image editors, sound editors, video games, etc.; as well as less resource-intensive applications, such as media players, web browsers, document processors, email clients, etc.

Both application optimizer engine 201 and applications 202A-N are executed by OS 203, which is in turn supported by EC/BIOS instructions/firmware 204. EC/BIOS firmware 204 is in communications with, and configured to receive data collected by, sensor modules or drivers 208A-N—which may abstract and/or interface with respective ones of sensors 112.

In various embodiments, logic system 200 also includes presence detection module or application programming interface (API) 205, energy estimation engine or API 206, data collection module or API 207, and/or smart audio engine 209 executed above OS 203.

Presence detection module 205 may process user presence data received by one or more of sensor modules 208A-N and it may determine, for example, whether an IHS's end-user is present or absent. Moreover, in cases where the end-user is present before the IHS, presence detection module 205 may further determine a distance of the end-user from the IHS continuously or at pre-determined time intervals. The detected or calculated distances may be used by presence detection module 205 to classify the user as being in the IHS's near-field, mid-field, or far-field.

Energy estimation engine 206 may include, for example, the MICROSOFT E3 engine, which is configured to provide energy usage data broken down by applications, services, tasks, and/or hardware in an IHS. In some cases, energy estimation engine 206 may use software and/or hardware sensors configured to determine, for example, whether any of applications 202A-N are being executed in the foreground or in the background (e.g., minimized, hidden, etc.) of the IHS's graphical user interface (GUI).

Data collection engine 207 may include any data collection service or process, such as, for example, the DELL DATA VAULT configured as a part of the DELL SUPPORT CENTER that collects information on system health, performance, and environment. In some cases, data collection engine 207 may receive and maintain a database or table that includes information related to IHS hardware utilization (e.g., by application, by thread, by hardware resource, etc.), power source (e.g., AC-plus-DC, AC-only, or DC-only), etc. In other cases, data collection engine 207 may collect information from one or more applications (e.g., calendar events, etc.)

In operation, application optimizer engine 201 monitors applications 202A-N executing on IHS 100. Particularly, application optimizer engine 201 may gather data associated with the subset of I/O parameters for a predetermined period of time (e.g., 15, 30, 45, 60 minutes or the like). For each of applications 202A-N, the classifier may use the gathered data to characterize the application's workload with various settings, memory usage, responsiveness, etc.

Proxy calendar module 209 may be configured to perform various methods described herein. Particularly, proxy calendar module 209 may create a proxy calendar for a user based upon various contextual vectors to provide inferences that can be employed for making policy changes to IHS configuration and settings (e.g., better runtime extension in DC mode or better charge mode adaptation in AC mode, etc.).

In operation, proxy calendar module 209 may collect contextual data across several variables and tag such data with start and end times, time of day, and day of week. Examples of contextual variables include, but are not limited to, a user's persona, a user location (e.g., on-campus indoor location, primary remote, other remote, etc.), AC or DC power mode, whether a conference application is active, audio and/or video activity, privacy settings, user presence, resource utilization activity, power state, network connection, etc. A set of variables states with time and day of week may be defined as a proxy calendar event.

Moreover, data on a sequence of events may be used to train a model using machine learning (ML) and/or artificial intelligence (AI) algorithms for predicting the next event in the sequence. For example, such a predictive model may be built using Compact Prediction Trees, Markow Chains, Long Short-Term Memory (LSTM), or the like. Each predicted event (with a given probability) may have a set of variables with individual states (e.g., UDP=near field, power state=DC, location=office_indoor, etc.). Using the model, testing can be done in silent mode, where no action is taken against the prediction. The predicted event may be compared against the actual event occurring on the IHS.

For users where reasonable accuracy is achieved, the model can predict the next event or next n-events. In some implementations, proxy calendar module 209 may maintain or improve the accuracy of a model by retraining the model against past data in silent mode. Additionally, or alternatively, the model output may be presented to the user for feedback which is then used to reinforce the model training.

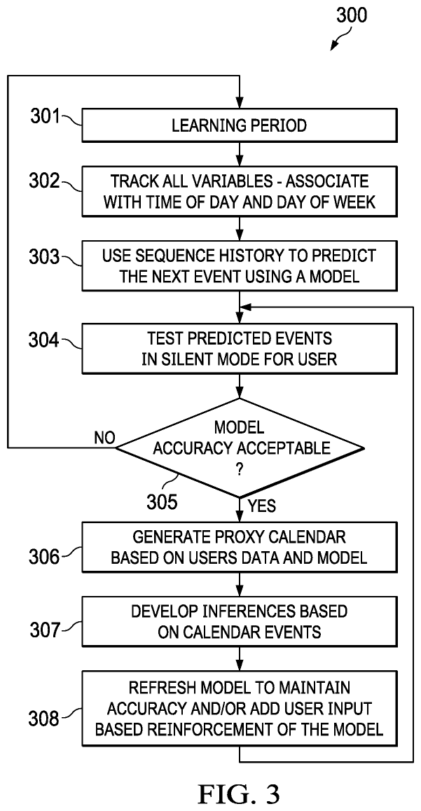

FIG. 3 is a flowchart illustrating an example of method 300 for managing an IHS based upon a proxy calendar. In some embodiments, method 300 may be executed, at least in part, by the operation of proxy calendar module 209 and/or application optimizer engine 201. Particularly, at 301, proxy calendar module 209 may be configured to initiate a learning period.

Meanwhile, application optimizer engine 201 may collect user context information and system context information, and it may make such information available to proxy calendar module 209. For example, application optimizer engine 201 may gather contextual inputs and place them a repository or database. Examples of contextual inputs include, but are not limited to: platform/sensor input, eye/facial tracking, I/O (keyboard, mouse, stylus, etc.), location, voice/gesture, biometrics, audio, application/OS/user, foreground and background applications, time spent using an application, other services and processes, time-of-day, calendar/scheduled events, system hardware settings, IHS posture, user proximity, user presence, environmental inputs, memory usage, a characteristic of a network connection, a power usage, attached peripherals, ambient sound, ambient lighting, weather events, etc.

System context information may be collected using sensors 208A-N, whereas user context information may be collected using presence detection module 205, energy estimation engine 206, and/or data collection module 207.

At 302, proxy calendar module 209 may track all contextual variables or any suitable combination thereof and associate it with a time of day and day of the week. At 303, proxy calendar module 209 may use a sequence history to predict the next event using an ML/AI model. At 304, proxy calendar module 209 may test predicted events in silent mode—that is, without taking action or alerting the user. Then, at 306, proxy calendar module 209 may determine whether the model's accuracy is acceptable (i.e., whether it meets a predetermined threshold value). If not, control returns to block 301.

At 306, if the model accuracy is deemed acceptable, proxy calendar module 209 generates a proxy calendar and populates it with proxy/predicted, upcoming events based upon the contextual data and the model. At 307, proxy calendar module 209 may develop inferences based upon the proxy calendar events. Then, at 308, proxy calendar module 209 may refresh the model to maintain accuracy and/or to add user input to reinforce the model before control returns to block 304.

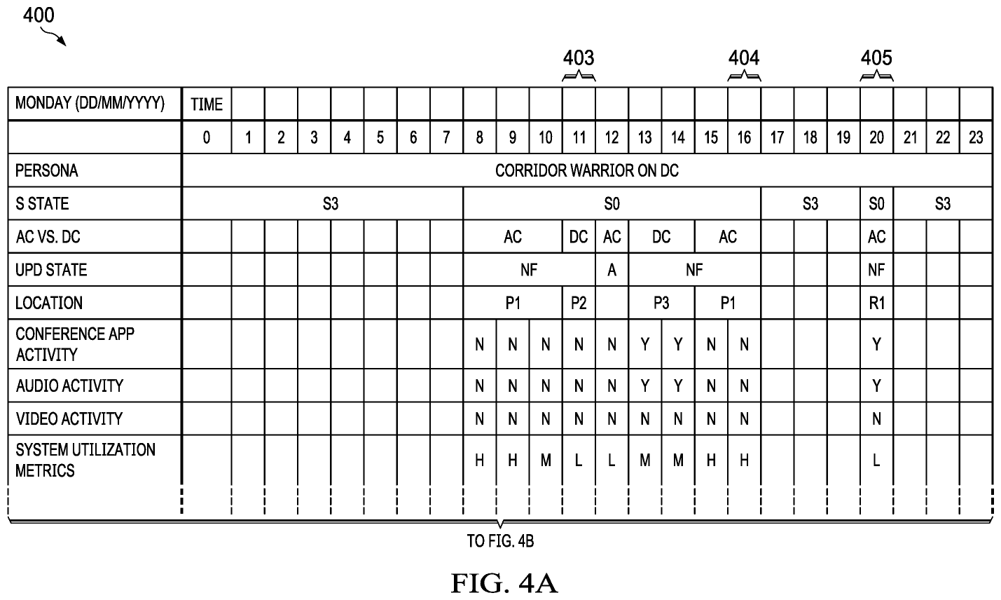

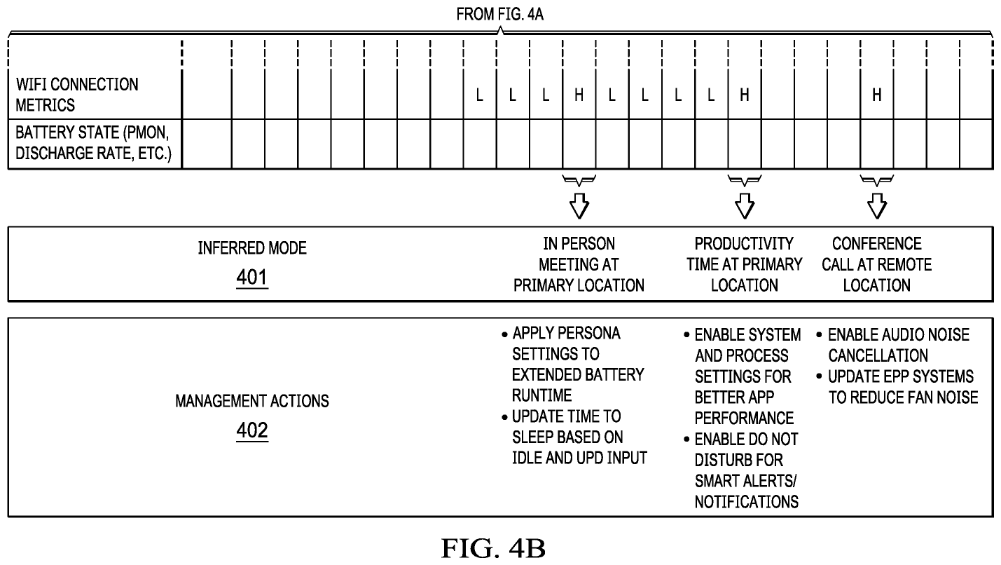

FIGS. 4A and 4B show a table illustrating an example use-case of managing an IHS based upon a proxy calendar, according to some embodiments. Particularly, proxy calendar 400 has been created for a specific day of the week, with hour-by-hour slots. In non-limiting example, the following contextual information is tracked: the user's persona, the “S” state (e.g., S0-S5), AC vs. DC power, user proximity or presence detection (UDP) state (e.g., near-field, away, etc.), the IHS's location (primary, secondary/remote, etc.), conference application activity (e.g., Y/N), audio activity (e.g., Y/N), video activity (e.g., Y/N), system utilization metrics (e.g., low, medium, or high), Wifi connection metrics (e.g., low, medium, or high), and battery state (e.g, discharge rate, etc.).

User personas may include, but are not limited to: (a) desktop replacement (when the user mainly uses a portable IHS like a desktop with very low battery usage); (b) corridor warrior (where there are frequent battery charge/discharge patterns of shorter durations); (c) deep discharge user (characterized by lower discharge power and long continuous time on discharge); or (d) performance user (characterized by higher battery discharge power and shorter discharge durations, for users who prefer performance over battery life).

In this case, proxy calendar module 209 includes three proxy events 403-405, each taking place at a different time and with different contextual characteristics. Inferred modes 401 may respectively include, for proxy event 403 an in-person meeting, for proxy event 404 a productivity time at a primary location (P1), and for proxy event 405 a conference call at a remote location. Accordingly, in anticipation of, for the duration of, and/or immediately upon termination of proxy events 403-405, for example, management actions 402 may respectively include: (a) for proxy event 403, applying settings to extent a battery runtime and updating the time-to-sleep based on idle and UPD input; (b) for proxy event 404, enabling do-not-disturb for smart alerts and notifications; and (c) for proxy event 405, enabling audio noise cancellation and updating cooling systems to reduce fan noise.

Accordingly, systems and methods described herein may be used to infer modes for a user, IHS, etc. in a commercial environment in the absence of an opt-in of “personal” user telemetry, including calendar application data, and then implementing intelligent behaviors such as system management, session management, intelligent audio-video configuration, intelligent security, etc. as actionable outcomes based upon the inferred modes. These systems and methods may be adapted and/or re-trained based upon (direct or implied) user feedback and reinforcement.

In some cases, these systems and methods may be used to construct a proxy schedule of user events and occurrence by calendar day/time using learned data across contextual variables and their relative co-occurrence, including events that may not be explicitly marked on the user's calendar. Moreover, because calendar data is not accessed these systems and methods may reduce the issues of privacy and access to personal data in an enterprise environment.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor; and
a memory coupled to the processor, the memory having program instructions stored thereon that, upon execution, cause the IHS to:
receive context information;
build a proxy calendar based upon the context information and in the absence of access to calendar application data; and
in response to the proxy calendar indicating an event, perform one or more management actions associated with the event.

2. The IHS of claim 1, wherein the context information comprises at least one of: a day of the week, or a time-of-day.

3. The IHS of claim 1, wherein the context information comprises an AC or DC power mode.

4. The IHS of claim 1, wherein the context information comprises a presence or proximity of a user to the IHS.

5. The IHS of claim 1, wherein the context information comprises a location of the IHS.

6. The IHS of claim 1, wherein the context information comprises a conferencing application activity.

7. The IHS of claim 1, wherein the context information comprises at least one of: audio activity, or video activity.

8. The IHS of claim 1, wherein the context information comprises an IHS utilization metric.

9. The IHS of claim 1, wherein the context information comprises a characteristic of a network connection.

10. The IHS of claim 1, wherein the context information comprises a characteristic of a battery utilization.

11. The IHS of claim 1, wherein the context information comprises an IHS posture.

12. The IHS of claim 1, wherein the event is selected from the group consisting of: (a) an in-person meeting at a primary location, (b) productivity time at a primary location, and (c) conference call from a remote location.

13. The IHS of claim 1, wherein the one or more management actions comprise selection of one of a plurality of fan settings.

14. The IHS of claim 1, wherein the one or more management actions comprise selection of one of a plurality of a power consumption settings.

15. The IHS of claim 1, wherein the one or more management actions comprise execution or cessation of a diagnostics or remediation process.

16. The IHS of claim 1, wherein the one or more management actions comprise execution or cessation of a system update process.

17. The IHS of claim 1, wherein the one or more management actions comprise execution or cessation of a telemetry collection process.

18. The IHS of claim 1, wherein the one or more management actions comprise setting the IHS in a selected security or locked mode.

19. A memory storage device having program instructions stored thereon that, upon execution by an Information Handling System (IHS), cause the IHS to:
request access to a user's calendar data;
receive, from the user, a denial of the request;
in response to the denial, build a proxy calendar based upon context information collected over time in lieu of calendar application data; and
in response to the proxy calendar indicating an upcoming event, perform one or more management actions associated with the event.

20. A method, comprising:
building a proxy calendar based upon context information obtained by an Information Handling System (IHS), wherein the context information excludes any calendar application data; and
in response to the proxy calendar indicating a predicted event, performing one or more management actions: (a) in anticipation of the event, (b) for a duration of the event, or (c) after termination the event.
